(19) United States
(12) Patent Application Publication
(10) Pub. No.: US 2026/0149572 A1
(43) Pub. Date: May 28, 2026

(54) Encryption, trapdoor generation and pattern detection methods and devices

(71) Applicant: ORANGE, ISSY-LES-MOULINEAUX (FR)

(72) Inventors: Olivier SANDERS, CHATILLON CEDEX (FR); Elie BOUSCATIE, CHATILLON CEDEX (FR)

(21) Appl. No.: 19/121,279

(22) PCT Filed: Oct. 9, 2023
(86) PCT No.: PCT/EP2023/077826

§ 371 Date: Apr. 15, 2025

(30) Foreign Application Priority Data
Oct. 17, 2022 (FR) FR2210693

(51) Int. Cl. H04L 9/08; H04L 9/30

(52) U.S. Cl. CPC H04L 9/0825; H04L 9/3013

(57) ABSTRACT

An encryption method in a system defining a public key (pk), to obtain a cipher (C) by encryption of data (m) including elementary characters m[i], the public key pk including: elements g_{c,i} for any integer i, the elements g_{c,i} being of the form g\hat{ }(a_{c,i}) where a_{c,i} is an integer and g a generator of a group G; elements hₖ, for any integer k, the elements hₖ being of the form g\hat{ }(1/bₖ) where bₖ is an integer; the generator g; a description of group G; and a description of a function H, the method including: selecting an integer a between 0 and p-1; calculating for any integer k between 1 and an integer t, a value Eₖ=H(hₖ\hat{ }(a)); calculating for any integer i between 1 and an integer u, a value Cᵢ equal to g_{m[i],i}\hat{ }a; and obtaining the cipher (C), said cipher consisting of the elements {Eₖ, Cᵢ}.

### BACKGROUND OF THE INVENTION

The invention relates to the field of telecommunications.

It more particularly concerns an encryption system called “searchable” encryption system, that is to say a system for detecting the presence of a pattern in an encrypted data stream.

Today, it is observed that most, approximately 90%, of the data streams exchanged on the telecommunications networks are encrypted. This is for example the case for HTTPS requests or DNS requests.

This encryption prevents the supervision of these data streams, for example for the detection of attacks (malware, denial of service, etc.) or the content filtering (parental control, etc.).

A solution for monitoring the encrypted data exchanged between a service provider, described in the document Lin-Shung Huang, Alex Rice, Erling Ellingsen, and Collin Jackson. Analyzing forged SSL certificates, 2014 IEEE Symposium on Security and Privacy, pages 83-97. IEEE Computer Society Press, May 2014, consists in using a proxy server that impersonates the service provider, obtains the encryption key, decrypts the characters, analyzes them in plaintext, re-encrypts them, and transmits them to the user. This solution is not satisfactory because it reveals the data to the proxy server.

Another family of cryptographic solutions in which the invention lies is called “searchable encryption”. The searchable encryption makes it possible to detect whether a data stream contains a cipher of a pattern, provided that certain information, usually called “trapdoor” and previously associated with this pattern, is held.

The following three documents propose such solutions:
[1] Justine Sherry, Chang Lan, Raluca Ada Popa, and Sylvia Ratnasamy. BlindBox: Deep Packet Inspection over Encrypted Traffic. In Proceedings of the 2015 ACM Conference on Special Interest Group on Data Communication, SIGCOMM'15;
[2] Nicolas Desmoulins, Pierre-Alain Fouque, Cristina Onete, and Olivier Sanders. Pattern matching on encrypted streams. In Thomas Peyrin and Steven Galbraith, editors, ASIACRYPT 2018; and
[3] Elie Bouscatié, Guilhem Castagnos and Olivier Sanders. Public Key Encryption with Flexible Pattern Matching. ASIACRYPT 2021.

The solution described in [1], based on symmetric encryption, only allows the detection of fixed-size patterns. It is therefore very limited and is especially not suitable for detecting malwares whose sizes can be very varied. The solutions described in [2] and [3] are very complex, in particular because they require the use of pairing-friendly elliptic curves.

The present invention proposes a searchable encryption system that overcomes shortcomings/drawbacks of the state of the art and/or provides improvements thereto.

### OBJECT AND SUMMARY OF THE INVENTION

Thus, and according to a first aspect, the invention concerns a method for generating a trapdoor in an encryption system, said trapdoor being associated with a pattern w comprising elementary characters w[1], . . . w[v] comprised in an alphabet supplemented by a special character that can replace any character of said alphabet, said system defining a secret key parameterized by integers n and t and including:
an integer a_{c,i} for any character c of the alphabet and for any integer i between 1 and the integer n; and
an integer bₖ for any integer k between 1 and the integer t;
   the method including steps of:
selecting an integer s comprised between 1 and the integer t; and
calculating a value T=bₛ*(r₁a_{w[1],1}+r₂a_{w[2],2}+ . . . +rᵥa_{w[v],v}), rᵢ=0 if w[i] is said special character and rᵢ is equal to an integer r otherwise,
   said trapdoor including the elements s, r, and T.

Correlatively, the invention concerns a device for generating a trapdoor in an encryption system, said trapdoor being associated with a pattern w comprising elementary characters w[1], . . . w[v] comprised in an alphabet supplemented by a special character that can replace any character of said alphabet, said system defining a secret key parameterized by integers n and t and including:
an integer a_{c,i} for any character c of the alphabet and for any integer i between 1 and the integer n; and
an integer bₖ for any integer k between 1 and the integer t;
   the device including:
a module for selecting an integer s comprised between 1 and the integer t; and
a module for calculating a value T=bₛ*(r₁a_{w[1],1}+r₂a_{w[2],2}+ . . . +rᵥa_{w[v],v}), rᵢ=0 if w[i] is said special character and rᵢ is equal to an integer r otherwise,
   the trapdoor including the elements s, r, and T.

The trapdoor thus generated makes it possible to detect a pattern of any size in a data stream by means of the detection procedure described later.

According to a second aspect, the invention concerns an encryption method implemented in an encryption system defining a public key, to obtain a cipher by encryption of data m including at least u elementary characters m[i], the public key including:
elements g_{c,i} for any integer i between 1 and an integer u, the elements g_{c,i} being of the form g\hat{ }(a_{c,i}) where a_{c,i} is an integer between 0 and an integer p-1 and g a generator of a group G of order p;
elements hₖ, for any integer k between 1 and an integer t, the elements hₖ being of the form g\hat{ }(1/bₖ) where bₖ is an integer between 0 and p-1;
the generator g;
a description of the group G; and
a description of a function H with a value in a finite set,
   said method including steps of:
selecting an integer a between 0 and p-1;
calculating for any integer k between 1 and t, a value Eₖ=H(hₖ\hat{ }(a));
calculating for any integer i between 1 and u, a value Cᵢ equal to g_{m[i],i}\hat{ }a,
obtaining the cipher, said cipher consisting of the elements {Eₖ, Cᵢ}.

Correlatively, the invention concerns an encryption device implemented in an encryption system defining a public key, the device being configured to obtain a cipher C by encryption of data m, including at least u elementary characters m[i], the public key including:
elements g_{c,i} for any integer i between 1 and an integer u, the elements g_{c,i} being of the form g\hat{ }(a_{c,i}) where a_{c,i} is an integer between 0 and an integer p-1 and g a generator of a group G of order p;
elements hₖ, for any integer k between 1 and an integer t, the elements hₖ being of the form g\hat{ }(1/bₖ) where bₖ is an integer between 0 and p-1;
the generator g of a group G;
a description of the group G; and
a description of a function H with a value in a finite set,
   said device including:
a module for selecting an integer a between 0 and p-1;
a first module for calculating, for any integer k between 1 and t, a value Eₖ=H(hₖ\hat{ }(a)),
a second module for calculating, for any integer i between 1 and u, a value Cᵢ equal to g_{m[i],i}\hat{ }a, and
   a module for obtaining the cipher, said cipher consisting of the elements {Eₖ, Cᵢ}.

The patterns and the data are character strings belonging to an alphabet. The characters can be of any type. For example, the characters can be coded on 2 bits, 8 bits, etc. The character strings can be DNA sequences.

Very advantageously, the encryption method is carried out independently of the patterns to be detected. Thus, the device that encrypts the data stream does not take into account, during the encryption, the patterns that will be possibly searched in the stream, nor the size of these patterns.

In one particular mode of implementation, the device that receives the encrypted stream generates the trapdoors associated with the patterns that are to be detected. It can perform the detection itself or assign this task to another device to which it communicates these trapdoors.

According to a third aspect, the invention concerns a method for detecting, in an encryption system, a pattern w in a cipher obtained by encryption of data, said pattern w comprising elementary characters (w[1], . . . w[v]) comprised in an alphabet supplemented by a special character that can replace any character of said alphabet, the method comprising steps of:
obtaining a trapdoor associated with said pattern;
calculating an element Q=C₁\hat{ }r₁* . . . *Cᵥ\hat{ }rᵥ with rᵢ=0 if w[i] is said special character and rᵢ=r otherwise;
calculating a value D equal to Q\hat{ }(1/T), where T is an element of said trapdoor;
calculating a value H(D) where H is a function H with a value in a finite set;
detecting that the data include said pattern w if H(D) is equal to Eₛ, where s is an integer comprised in said trapdoor.

Correlatively, the invention concerns a device for detecting, in an encryption system, a pattern w in a cipher obtained by encryption of data, said pattern comprising elementary characters (w[1], . . . w[v]) comprised in an alphabet supplemented by a special character that can replace any character of said alphabet, the device comprising:
a module for obtaining a trapdoor associated with said pattern;
a first module for calculating an element Q=C₁\hat{ }r₁* . . . *Cᵥ\hat{ }rᵥ with rᵢ=0 if w[i] is said special character and rᵢ=r otherwise;
a second module for calculating a value D equal to Q\hat{ }(1/T), where T is an element of said trapdoor;
a third module for calculating a value H(D) where H is a function H with a value in a finite set;
a detection module configured to detect that the data include said pattern w if H(D) is equal to Eₛ, where s is an integer comprised in said trapdoor.

In one embodiment, the cipher is obtained by an encryption method as mentioned above and the trapdoor is obtained by a trapdoor generation method as mentioned above.

The method for detecting the presence of a pattern is of very low complexity compared to the solutions described in documents [2] and [3] introduced previously, these requiring the use of pairing-friendly elliptic curves.

Advantageously, the detection device does not need any knowledge on the plaintext data that have been encrypted. The pattern can be detected without decrypting the data stream.

Very advantageously, the pattern can be searched at any position in the stream. In accordance with the invention, the detection takes place on the w first characters of the cipher. To shift the position of the pattern to be detected, it is sufficient to start said pattern with an appropriate number of special characters.

The invention also relates to a method for decrypting a cipher obtained by encryption of data including at least u elementary characters, the cipher being generated in accordance with an encryption method as mentioned above, the decryption method comprising:
obtaining a trapdoor associated with each of the distinct elementary data of the data stream, said trapdoor being generated in accordance with a trapdoor generation method as mentioned above,
detecting the presence of said trapdoor, in accordance with the pattern detection method as mentioned above.

The invention also relates to an encryption system comprising:
a trapdoor generation device,
an encryption device, and
a device for detecting the presence of a pattern in a cipher as mentioned above.

The present invention can especially be used to detect malware, by generating trapdoors associated with these malwares. A list of patterns for malware detection is published at https://www.snort.org/.

The present invention can also be used to perform parental control by generating trapdoors corresponding to keywords to be filtered, and by blocking the streams that include these keywords.

In one particular embodiment, the different steps of the trapdoor generation, encryption and detection methods are determined by computer program instructions or are implemented by a silicon chip that comprises transistors adapted to constitute logic gates of a non-programmable wired logic.

Consequently, the invention also relates to a computer program on an information medium, this program being capable of being implemented in a controller computer, this program including instructions adapted to the implementation of the steps of a method as described above.

This program can use any programming language, and be in the form of source code, object code, or intermediate code between source code and object code, such as in a partially compiled form, or in any other desirable form.

The invention also relates to an information medium readable by a computer, and including instructions of a computer program as mentioned above. The information medium can be any entity or device capable of storing the program. For example, the medium can include a storage means, such as a ROM, a non-volatile memory of the flash type or even a magnetic recording means, for example a hard disk. On the other hand, the information medium can be a transmissible medium such as an electrical or optical signal, which can be conveyed via an electrical or optical cable, by radio or by other means. The program according to the invention can especially be downloaded on an Internet-type network. Alternatively, the information medium may be an integrated circuit in which the program is incorporated, the circuit being adapted to execute or to be used in the execution of the method in question.

### BRIEF DESCRIPTION OF THE DRAWINGS

Other characteristics and advantages of the present invention will emerge from the description given below, with reference to the appended drawings which illustrate exemplary embodiments thereof without any limitation. In the figures:

FIG. 1 represents an encryptable encryption system in accordance with one particular embodiment;

FIG. 2 represents the main steps of a key generation method in accordance with one particular embodiment;

FIG. 3 represents the main steps of an encryption method in accordance with one particular embodiment;

FIG. 4 represents the main steps of a trapdoor generation method in accordance with one particular embodiment;

FIG. 5 represents the main steps of a method for detecting the presence of a pattern in accordance with one particular embodiment;

FIG. 6 represents an encryption device in accordance with one particular embodiment;

FIG. 7 represents a trapdoor generation device in accordance with one particular embodiment;

FIG. 8 represents a device for detecting the presence of a pattern in accordance with one particular embodiment.

### DESCRIPTION OF THE EMBODIMENTS

It should be noted that a usual notation is here used in cryptography in which:
“x_i” represents “x subscript i”, namely “xi”;
“g\hat{ }x” represents “g to the power of x”, namely “gx”,
the product is schematized by an asterisk: “*” when many indexed factors intervene. A notation where the asterisk is absent is also possible: “2n” for “2*n”,
the addition is conventionally schematized by the sign “+” when many indexed factors intervene.

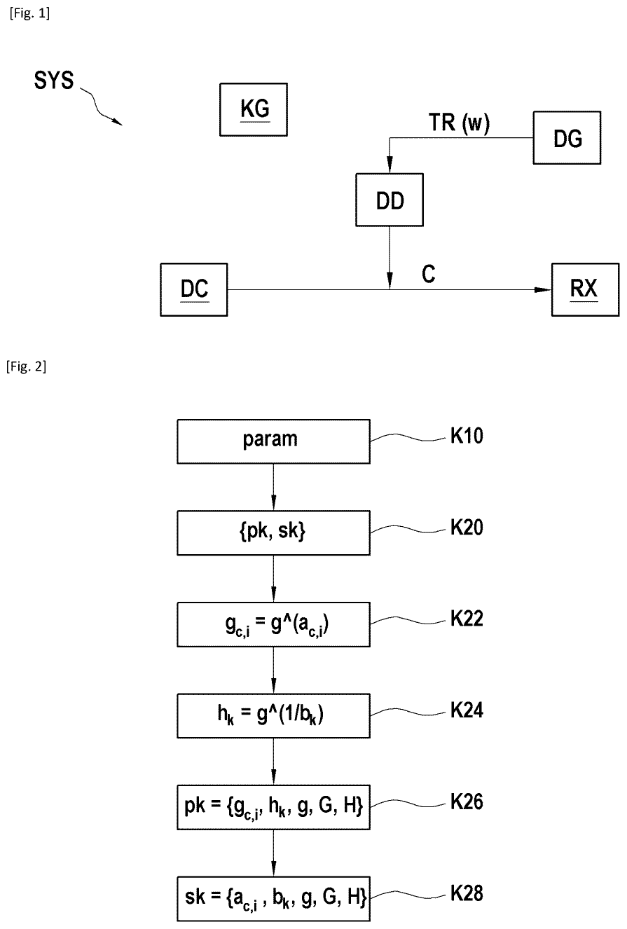

FIG. 1 represents a searchable encryption system SYS in accordance with the invention. This system SYS makes it possible to detect the presence of a pattern w in an encrypted data stream C.

In this figure, an encryption device DC encrypts plaintext data to generate an encrypted data stream C and to send this encrypted stream C to a decryption device RX configured to decrypt this encrypted stream and recover the plaintext data stream.

The encryption system SYS is based on a public key cryptography system. To this end, it relies on a secret key sk and an associated public key pk. It is assumed that a key generation device KG is arranged to generate the pair of keys sk, pk according to a known method.

A trapdoor generation device DG is configured to generate, for a given pattern w, a trapdoor TR(w) associated with this pattern. The trapdoor generation device DG is represented as independent but can for example be integrated into the decryption device RX.

The trapdoor TR(w) is intended to be used by a detection device DD to detect the presence of the pattern w in the encrypted stream. The trapdoor generation device DG is configured to transmit the trapdoor(s) it has generated to the detection device DD.

The encryption system SYS thus comprises the trapdoor generation device DG, the encryption device DC, and the detection device DD.

In the embodiment described here, the encryption system SYS uses a group G of order p. This group can be any group, but in the remainder of the description, it can in particular be a group of points of an elliptic curve, or a multiplicative subgroup of a finite field.

Subsequently, the data are processed as character strings. These characters belong to an alphabet S.

FIG. 2 represents the main steps K10 to K28 that can be implemented by the key generation device KG in accordance with one particular embodiment. The secret key is parameterized by integers n and t.

The key generation method includes a first step K10 of selecting the parameters of the system, these parameters comprising:
n: a maximum number of characters that can be encrypted by the encryption method;
t: an integer;
p: a prime number;
G: a group of order p;
g: an element of G which is not the neutral element, called generator;
H: a function H taking as input any bit string and with a value in a finite set D. In practice any cryptographic hash function, such as SHA-256 or SHA-3, can for example be used.

During a step K20, the key generation method generates a pair of keys {pk, sk} including a secret key sk and an associated public key pk.

During a step K22, for any character c of the alphabet S and for any integer i between 1 and n, the key generation method selects an integer a_{c,i} between 0 and p-1 and calculates g_{c,i}=g\hat{ }(a_{c,i}).

During a step K24, for any integer k between 1 and t, the method selects an integer bₖ between 0 and p-1 and calculates hₖ=g\hat{ }(1/bₖ).

During a step K26, the method defines the public key pk of the cryptographic system as the set consisting of:
the elements g_{c,i}, hₖ and g;
the description of the group G; and
the description of the function H.
   pk={g_{c,i}, hₖ, g, G, H} is noted.

During a step K28, the method defines the secret key sk of the cryptographic system as the set consisting of:
the integers a_{c,i} and bₖ;
or any information that allows them to be found.
   sk={a_{c,i}, bₖ, g, G, H} is noted

As is known, the public key pk is assumed to be known to all the devices of the system SYS, in particular by the encryption device DC. The secret key sk is known to the trapdoor generation device DT and to the decryption device RX.

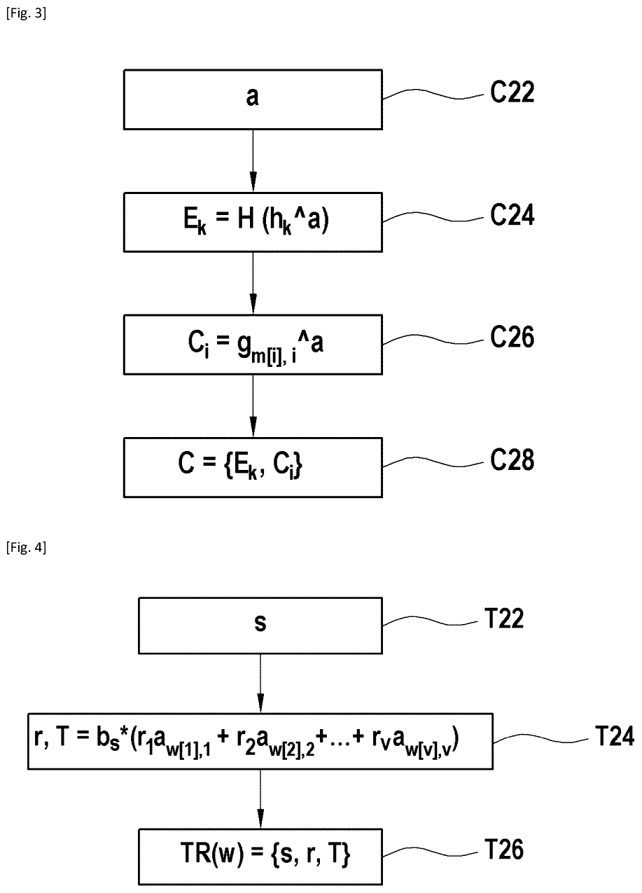

FIG. 3 represents the main steps C22 to C28 of an encryption method in accordance with one particular embodiment.

The encryption method makes it possible to encrypt any character string m=m[1], m[2], . . . , m[u] in which the size u of this string is less than or equal to the maximum size n of the data that can be encrypted and decrypted by the system SYS. The characters m[i], whatever i, are elements of the alphabet S.

This encryption method uses the public key pk={g_{c,i}, hₖ, g, G, H} to encrypt the data.

During a step C22, the encryption method selects an integer a between 0 and p-1.

During a step C24, the encryption method calculates, for any integer k between 1 and t, Eₖ=H(hₖ\hat{ }(a)). It is recalled here that the function H takes as input any bit string and with a value in a finite set D.

During a step C26, the encryption method calculates, for any integer i between 1 and u, Cᵢ=g_{m[i],i}\hat{ }a.

During a step C28, the encryption method obtains the cipher C consisting of all the elements Eₖ and Cᵢ. C={Eₖ, Cᵢ} is noted. It is noted that this cipher includes t+u elements with:
t: integer chosen as part of the parameters of the system; and
u: size of the data to be encrypted.

In the embodiment described here, the encryption method is implemented by the encryption device DC and the encryption device DC sends the cipher C to the decryption device RX.

FIG. 4 represents the main steps T22 to T26 of a trapdoor generation method in accordance with one particular embodiment.

The trapdoor generation method makes it possible to generate a trapdoor for any pattern w=w[1], w[2], . . . , w[v] in which the size v of the pattern is less than or equal to the maximum size n of the data that can be encrypted and decrypted by the system SYS, and w[i], whatever i, an element of the alphabet S or a special character “*”.

This method uses the secret key sk={a_{c,i}, bₖ, g, G, H}.

During a step T22, the trapdoor generation method selects an integer s between 1 and t.

During a step T24, the trapdoor generation method selects an integer r between 1 and p-1 and calculates T=bₛ*(r₁a_{w[1],1}+r₂a_{w[2],2}+ . . . +rᵥa_{w[v],v}), where:
rᵢ=0 if w[i] is the special character “*” and
rᵢ=r otherwise.

In one particular embodiment r=1 for all the trapdoors.

During a step T26, the generation method obtains the trapdoor TR(w) for the pattern w, with TR(w)={s, r, T}. It is noted that r does not need to be secret.

In the embodiment described here, the trapdoor generation method is implemented by the decryption device RX.

In the embodiment described here, the decryption device RX sends the trapdoor TR(w) to the device DD for detecting the presence of a pattern.

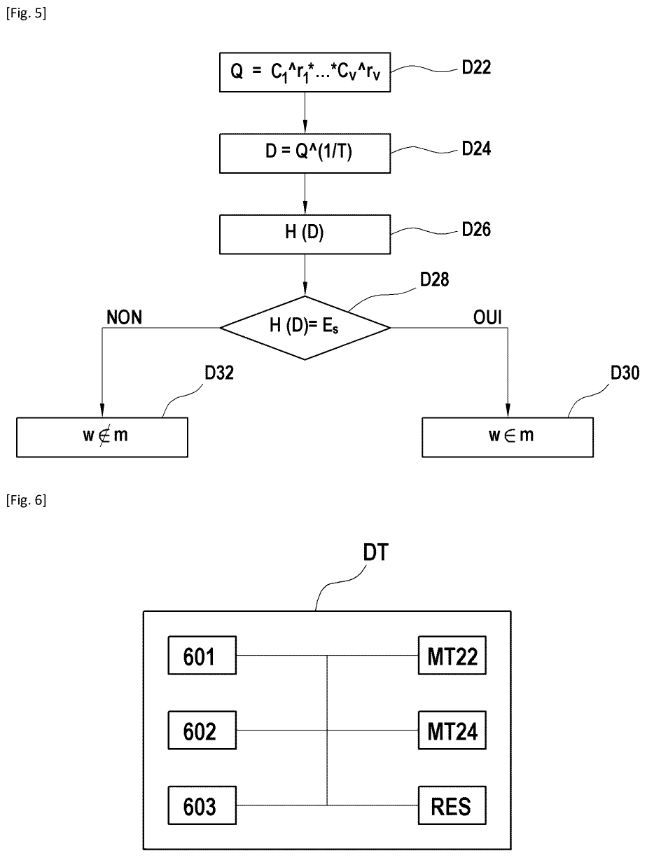

FIG. 5 represents the main steps D22 to D32 of a method for detecting the presence of a pattern in accordance with one particular embodiment.

The method for detecting the presence of a pattern allows testing whether the pattern w=w[1], w[2], . . . , w[v] corresponds to v elements of the plaintext data m that have been encrypted to generate the cipher C={Eₖ, Cᵢ}, k being comprised between 1 and t, i being comprised between 1 and u.

This method uses:
the alphabet S;
the integer t
the size u of the character string in plaintext before encryption
the length v of the pattern w
the cipher C={Eₖ, Cᵢ};
the trapdoor TR(w)={s, r, T} associated with this pattern w; and
the function H.

In the embodiment described herein, this detection method includes the following steps D22 to D32.

During a step D22, the detection method calculates an element Q=C₁\hat{ }r₁* . . . *Cᵥ\hat{ }rᵥ with:
rᵢ=0 if w[i] is the special character “*” and
rᵢ=r otherwise.

During a step D24, the detection method calculates an element D=Q\hat{ }(1/T).

During a step D26, the detection method calculates H(D).

During a step D28, the detection method compares H(D) with Eₛ, s being the first element of the trapdoor TR(w) and Eₛ, the element of rank s of the cipher C.

If H(D)=Eₛ, the detection method determines or detects (step D30) that the data m, encrypted in C, include the pattern w. Otherwise, the detection method determines (step D32) that the data m, encrypted in C, do not include the pattern w. This detection is carried out without decrypting the cipher C.

The proof of the validity of the encryption presented above is provided below.

If a pattern w=w[1], . . . , w[v] is present in data m=m[1], . . . , m[u], then w[i]=m[i] for any i between 1 and v such that w[i] is different from the special character “*”.

Let J refer to the set of such i.

Then, the element Q calculated in step D22 is exactly the product of the Cᵢ\hat{ }r for i belonging to J.

Since Ci=g_{m[i],i}\hat{ }a=g\hat{ }(a*a_{m[i],i})=g\hat{ }(a*a_{w[i],i}), this product is exactly g\hat{ }(a*r*A), where A is the sum of the a_{w[i],i} for i belonging to J.

Thus Q\hat{ }(1/T) simplifies this sum and gives exactly g\hat{ }(a/bₛ). By calculating the image by H of this last value we fall back exactly on Eₛ.

Conversely, if the pattern differs, even at a single position, from the encrypted character sequence, it can be proven that the probability of falling back on Eₛ is at most 1/p, which is negligible in practice. Indeed, p can be chosen for example close to 2²⁵⁶.

The invention also relates to a method for decrypting a cipher obtained by encryption of data including at least u elementary characters, the cipher being generated in accordance with an encryption method as described above, the decryption method comprising:
obtaining a trapdoor associated with each of the distinct elementary data of the data stream, said trapdoor being generated in accordance with a method for generating a trapdoor as described above,
detecting the presence of this trapdoor, in accordance with the method for detecting a pattern as described above.

A device DG for generating a trapdoor in an encryption system, according to one exemplary embodiment, will now be described in relation to FIG. 6. This device DG is a computer equipment, such as a computer.

The trapdoor generation DG device comprises:
a processing unit or processor 601, or CPU (Central Processing Unit), intended to load instructions into memory, to execute them, to perform operations;
a set of memories, including a volatile memory 602, or RAM (Random Access Memory) used to execute code instructions, store variables, etc., and a storage memory 603 of the EEPROM (Electrically Erasable Programmable Read Only Memory) type. Especially, the storage memory 603 is arranged to store a trapdoor generation software module which comprises code instructions for implementing the steps of the trapdoor generation method as described above. The storage memory 603 is also arranged to store in a secure area the secret key sk of the encryption system.

The trapdoor generation device DG also comprises:
a module MT22 for selecting an integer s comprised between 1 and t;
a module MT24 for calculating a value T=bₛ*(r₁a_{w[1],1}+r₂a_{w[2],2}+ . . . +rᵥa_{w[v],v}), rᵢ=0 if w[i] is said special character and rᵢ is equal to an integer r otherwise, and
a module RES for restoring the trapdoor including the elements s, r, and T.

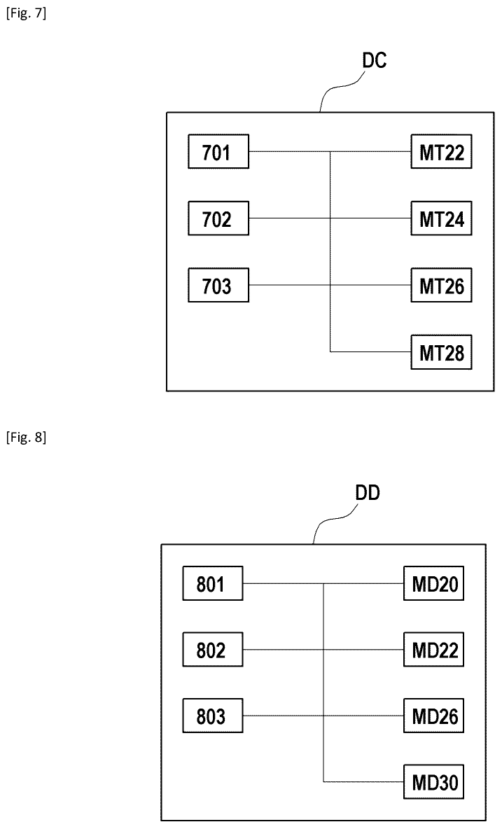

An encryption device DC, according to one exemplary embodiment, will now be described in relation to FIG. 7. This encryption device DC is a computer equipment, such as a computer.

It comprises:
a processing unit or processor 701, or CPU, intended to load instructions into memory, to execute them, to perform operations;
a set of memories, including a volatile memory 702, or RAM used to execute code instructions, store variables, etc., and a storage memory 703 of the EEPROM type. Especially, the storage memory 703 is arranged to store an encryption software module which comprises code instructions for implementing the steps of the encryption method as described above. The memory 703 is also arranged to store the public key pk of the encryption system.

The encryption device DC also comprises:
a module MC22 for selecting an integer a between 0 and p-1;
a first module MC24 for calculating, for any integer k between 1 and an integer t, a value Eₖ=H(hₖ\hat{ }(a));
a second module MC26 for calculating, for any integer i between 1 and an integer u, a value Cᵢ equal to g_{m[i],i}\hat{ }a, and
a module MC28 for obtaining the cipher, said cipher consisting of the elements {Eₖ, Cᵢ}.

A device DD for detecting the presence of a pattern, according to one exemplary embodiment, will now be described in relation to FIG. 8. This device DD is a computer equipment, such as a computer.

It comprises:
a processing unit or processor 801, or CPU, intended to load instructions into memory, to execute them, to perform operations;
a set of memories, including a volatile memory 802, or RAM used to execute code instructions, store variables, etc., and a storage memory 803 of the EEPROM type. Especially, the storage memory 803 is arranged to store a software module for detecting a pattern in a stream that comprises code instructions for implementing the steps of the pattern detection method as described above.

The device DD for detecting the presence of a pattern also comprises:
a module MD20 for obtaining a trapdoor TR(w) associated with said pattern;
a first module MD22 for calculating an element Q=C₁\hat{ }r₁* . . . *Cᵥ\hat{ }rᵥ with rᵢ=0 if w[i] is said special character and rᵢ=r otherwise;
a second module MD24 for calculating a value D equal to Q\hat{ }(1/T), where T is an element of said trapdoor;
a third module MD26 for calculating a value H(D) where H is a function H with a value in a finite set;
a detection module MD30 configured to detect that the data (m) include said pattern (w) if H(D) is equal to Eₛ, where s is an integer comprised in said trapdoor.

1. A method implemented by a device and comprising:
generating a trapdoor in an encryption system, said trapdoor being associated with a pattern w comprising elementary characters w[1], . . . w[v] comprised in an alphabet supplemented by a special character that can replace any character of said alphabet,
said system defining a secret key parameterized by integers n and t and including:
an integer a_{c,i} for any character c of the alphabet and for any integer i between 1 and the integer n; and
an integer bₖ for any integer k between 1 and the integer t;
the generating including:
selecting an integer s comprised between 1 and the integer t; and
calculating a value T=bₛ*(r₁a_{w[1],1}+r₂a_{w[2],2}+ . . . +rᵥa_{w[v],v}), rᵢ=0 if w[i] is said special character and rᵢ is equal to an integer r otherwise,
said trapdoor including elements s, r, and T.

2. A method implemented by a device and comprising:
encryption method implemented by a device in an encryption system defining a public key, to obtain a cipher by encryption of data including at least u elementary characters m[i], the public key pk including:
elements g_{c,i} for any integer i between 1 and an integer u, the elements g_{c,i} being of the form g\hat{ }(a_{c,i}) where a_{c,i} is an integer between 0 and an integer p-1 and g a generator of a group G of order p;
elements hₖ, for any integer k between 1 and an integer t, the elements hₖ being of the form g\hat{ }(1/bₖ) where bₖ is an integer between 0 and p-1;
the generator g;
a description of the group G; and
a description of a function H with a value in a finite set,
said method including:
selecting an integer a between 0 and p-1;
calculating for any integer k between 1 and t, a value Eₖ=H(hₖ\hat{ }(a));
calculating for any integer i between 1 and u, a value Cᵢ equal to g_{m[i],i}\hat{ }a; and
obtaining the cipher, said cipher consisting of the elements {Eₖ, Cᵢ}.

3. A method implemented by a device and comprising:
detecting, in an encryption system, a pattern in a cipher obtained by encryption of data, said pattern comprising elementary characters w[1], . . . w[v] comprised in an alphabet supplemented by a special character that can replace any character of said alphabet, the detecting comprising:
obtaining a trapdoor associated with said pattern;
calculating an element Q=C₁\hat{ }r₁* . . . *Cᵥ\hat{ }rᵥ with rᵢ=0 if w[i] is said special character and rᵢ=r otherwise;
calculating a value D equal to Q\hat{ }(1/T), where T is an element of said trapdoor;
calculating a value H(D) where H is a function H with a value in a finite set;
calculating that the data include said pattern if H(D) is equal to Eₛ, where s is an integer comprised in said trapdoor.

4. (canceled)

5. A non-transitory computer readable medium comprising a computer program stored thereon comprising program code instructions to control execution of the method according to claim 1, when the program is executed on said device.

6. (canceled)

7. A non-transitory computer readable medium comprising a program stored thereon comprising program code instructions intended to control execution of the encryption method according to claim 2, when the program is executed on said device.

8. A device for detecting, in an encryption system, presence of a pattern in a cipher obtained by encryption of data, said pattern comprising elementary characters w[1], . . . w[v] comprised in an alphabet supplemented by a special character that can replace any character of said alphabet, the device comprising:
at least one processor; and
at least one non-transitory computer readable medium comprising instructions stored thereon which when executed by the at least one processor configure the device to detect the presence of the cipher, the detecting comprising:
obtaining a trapdoor associated with said pattern;
calculating an element Q=C₁\hat{ }r₁* . . . *Cᵥ\hat{ }rᵥ with rᵢ=0 if w[i] is said special character and rᵢ=r otherwise;
calculating a value D equal to Q\hat{ }(1/T), where T is an element of said trapdoor;
calculating a value H(D) where H is a function H with a value in a finite set;
detecting that the data include said pattern if H(D) is equal to Eₛ, where s is an integer comprised in said trapdoor.

9. A non-transitory computer readable medium comprising a program stored thereon comprising program code instructions to control execution of the method according to claim 3, when the program is executed on said device.

10. method comprising:
decrypting a cipher obtained by encryption of data including at least u elementary characters m[i], the cipher being generated in accordance with the method according to claim 2, the decrypting comprising:
obtaining a trapdoor associated with each of the distinct elementary data of the data stream, said trapdoor being generated in an encryption system, said trapdoor being associated with a pattern w comprising elementary characters w[1], . . . w[v] comprised in an alphabet supplemented by a special character that can replace any character of said alphabet,
said system defining a secret key parameterized by integers n and t and including:
an integer a_{c,i} for any character c of the alphabet and for any integer i between 1 and the integer n; and
an integer bₖ for any integer k between 1 and the integer t;
the generating including:
selecting an integer s comprised between 1 and the integer t; and
calculating a value T=bₛ*(r₁a_{w[1],1}+r₂a_{w[2],2}+ . . . +rᵥa_{w[v],v}), rᵢ=0 if w[i] is said special character and rᵢ is equal to an integer r otherwise,
said trapdoor including elements s, r, and T; and
detecting presence of said trapdoor by detecting the pattern in the cipher, the detecting comprising:
obtaining the trapdoor associated with said pattern;
calculating an element Q=C₁\hat{ }r₁* . . . *Cᵥ\hat{ }rᵥ with rᵢ=0 if w[i] is said special character and rᵢ=r otherwise;
calculating a value D equal to Q\hat{ }(1/T), where T is an element of said trapdoor;
calculating a value H(D) where H is a function H with a value in a finite set;
calculating that the data include said pattern if H(D) is equal to Eₛ, where s is an integer comprised in said trapdoor.

11. An encryption system comprising:
a trapdoor generation device for generating a trapdoor in an encryption system, said trapdoor being associated with a pattern comprising elementary characters comprised in an alphabet supplemented by a special character that can replace any character of said alphabet, said system defining a secret key parameterized by integers n and t and including:
an integer a_{c,i} for any character c of the alphabet and for any integer i between 1 and the integer n; and
an integer bₖ for any integer k between 1 and the integer t;
the trapdoor generation device including:
a module for selecting an integer s comprised between 1 and t; and
a module for calculating a value T=bₛ*(r₁a_{w[1],1}+r₂a_{w[2],2}+ . . . +rᵥa_{w[v],v}), rᵢ=0 if w[i] is said special character and rᵢ is equal to an integer r otherwise,
said trapdoor including the elements s, r, and T;
an encryption device implemented in an encryption system defining a public key, the encryption device being configured to obtain a cipher by encryption of data, including at least u elementary characters m[i], the public key (pk) including:
elements g_{c,i} for any integer i between 1 and an integer u, the elements g_{c,i} being of the form g\hat{ }(a_{c,i}) where a_{c,i} is an integer between 0 and an integer p-1 and g a generator of a group G of order p;
elements hₖ, for any integer k between 1 and an integer t, the elements hₖ being of the form g\hat{ }(1/bₖ) where bₖ is an integer between 0 and p-1;
the generator g of a group G;
a description of the group G; and
a description of a function H with a value in a finite set,
said encryption device including:
a module for selecting an integer a between 0 and p-1;
a first module for calculating, for any integer k between 1 and t, a value Eₖ=H(hₖ\hat{ }(a));
a second module for calculating, for any integer i between 1 and u, a value Cᵢ equal to g_{m[i],i}\hat{ }a, and
a module for obtaining the cipher, said cipher consisting of the elements {Eₖ, Cᵢ}; and
a detecting device for detecting the presence of a pattern in a cipher according to claim 8.
